(19) United States
(12) Patent Application Publication
(10) Pub. No.: US 2010/0148920 A1
(43) Pub. Date: Jun. 17, 2010

(54) AUTOMATED PRESENCE DETECTOR FOR MOTOR VEHICLES

(76) Inventors: Earl Warren Philmon, Raleigh, NC (US); Collin Regault Rountree, Johns Creek, GA (US); Paul E. Rubenstein, Roswell, GA (US); Hannah W. Wang, Johns Creek, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/652,791

(22) Filed: Jan. 6, 2010

Related U.S. Application Data
(63) Continuation-in-part of application No. 12/334,797, filed on Dec. 15, 2008.

(51) Int. Cl. G06F 7/04; G01S 19/24

(52) U.S. Cl. 340/5.2; 342/357.07; 455/41.2

(57) ABSTRACT

The disclosure presents various embodiments, as well as features and aspects thereof, of a presence detection technique and system used in motor vehicles. Exemplary embodiments recognize the presence of a motor vehicle driver in, or near, a motor vehicle. Based on the recognized presence of a driver, embodiments of an automated presence detector for motor vehicles may inhibit, block or otherwise restrict access to services or applications associated with the driver's mobile device. To recognize the presence of a motor vehicle driver, embodiments may employ wireless radio frequency standards, such as Bluetooth, position indication technologies, such as GPS, or any other means suitable for correlating the physical presence of a driver with a motor vehicle.

### CROSS REFERENCE TO RELATED APPLICATIONS

This application is a continuation-in-part of the United States patent application having Ser. No. 12/334,797, filed on Dec. 15, 2008 and entitled PRESENCE BASED COMMUNICATION CONTROL, the entirety of which is hereby incorporated by reference. This application is related to the United States patent application entitled AUTOMATED PRESENCE FOR SET TOP BOXES, filed concurrently herewith and having an attorney docket number of 07001.1520, the entirety of which is hereby incorporated by reference.

### BACKGROUND

Perhaps any time that motor vehicle related safety can be automated, it is a good thing. Such a philosophy explains the merits of, among numerous other things, an automatic seat belt, a deactivation feature for air bags should too little seat weight be sensed, a governor that limits vehicle speed, a function that prevents an automobile from being cranked unless the transmission is in “park,” and even a function that prevents an automobile from being cranked if the driver fails an integrated breathalyzer test. Generally, removing a vehicle driver's need to be proactive in the pursuit of safety is a desirable goal as doing so may guarantee safety measures that would be otherwise eschewed by the average operator of a motor vehicle.

Many safety features and functions for motor vehicles are the result of the automobile industry's relentless pursuit to improve both the safety and marketability of their product. The existence of other safety related features common in motor vehicles, or common in conjunction with the use of motor vehicles, however, are directly attributable to government regulation. For example, many government agencies and legislative bodies have outlawed the use of personal communications devices by drivers, noting the ever increasing danger of vehicle drivers being distracted by mobile phones or similar devices.

Alarmingly, it has become almost commonplace to witness an automobile driver texting, emailing, “tweeting,” web browsing or otherwise just plain fiddling with a personal device while he's supposed to be paying attention to the business of driving. Such behavior is inarguably distracting for the driver and, as a result, may be the key ingredient to a recipe for disaster.

Though regulations outlawing the use of personal communication devices while driving or, alternatively, mandating the use of “hands free” technology by drivers seeking to interface with a personal communication device, certainly have an impact on driving safety, the ultimate effectiveness of those regulations directly correlates with an individual driver's self discipline and proactive bent toward safety. When it comes to increasing driving safety, therefore, what is needed is a technology solution that will automatically limit an automobile driver from unsafely interfacing with a personal communication device.

To offer such a solution, some have proposed deactivation of a personal communication device based on a sensed threshold of movement of the device, i.e. restricting the use of a personal communication device in a motor vehicle that is moving. Such a solution, however, has generally been dismissed as too restrictive and possibly prone to actually increasing dangerous behavior as drivers could be tempted to, for example, continue texting during a critical low speed moment such as advancing through a two-way stop.

Existing systems and methodologies for automatically restricting the driver of a motor vehicle from unsafely interfacing with a personal communication device are either ineffective or inadequate. In the name of safety, legislative bodies, parents of teenage drivers and responsible drivers in general, among other interested parties, are desirous of a system and methodology that can increase driving safety without requiring a driver to be proactive in pursuit of that safety. A system and method that takes advantage of embedded position identification functionalities and/or wireless radio frequency capabilities, such as Bluetooth, in modern day motor vehicles and personal communication devices can fill just such a need.

### BRIEF SUMMARY

The disclosure presents various embodiments, as well as features and aspects thereof, of a presence detection technique and system used in motor vehicles. Exemplary embodiments recognize the presence of a motor vehicle driver in, or near, a motor vehicle. Based on the recognized presence of a driver, embodiments of an automated presence detector for motor vehicles may inhibit, block or otherwise restrict access to services or applications associated with the driver's mobile device. Alternatively, other embodiments, instead of restricting access per se, may operate to enable access to services or applications associated with the driver's mobile device. Regardless of whether an embodiment is configured to limit access or enable access, to recognize the presence of a motor vehicle driver, embodiments may employ wireless radio frequency standards, such as Bluetooth, position indication technologies, such as GPS, or any other means suitable for correlating the physical presence of a driver with a motor vehicle.

The presence of a driver in a motor vehicle can be automatically detected by using Bluetooth technology or another similar radio frequency standard. A driver carrying a Bluetooth enabled device can be recognized via a receiver integrated within the controls of a motor vehicle. The motor vehicle controls, upon recognition of a driver's presence (such as via a Bluetooth receiver), may transmit actuation signals to the driver's mobile device. Upon receipt of the actuation signals, an application on the mobile device may deactivate, or limit access to, certain functions, features or other applications on the mobile device. Alternatively, some embodiments may be operable to activate, as opposed to deactivate, certain functions of a mobile device. The term “mobile device,” as used in this disclosure, may generally reference any electronic device such as, but not limited to, a cellular telephone, a personal digital assistant (PDA), an “IPod,” a pager, a camera, or a personal computer.

Other embodiments of an automated presence detector for motor vehicles may comprise an application running on a mobile device that does not require the receipt of actuation signals from the controls of a motor vehicle. In such embodiments, the application on the mobile device recognizes the presence of the motor vehicle and subsequently deactivates, activates, or limits access to certain functions, features or other applications on the mobile device.

Importantly, it is contemplated that some embodiments of an automated presence detector for motor vehicles will be operable to evaluate the relative strength of signal transmissions emanating from either or both of the motor vehicle controls and the mobile device. In such embodiments, thresholds may be configured such that access to mobile device features is not restricted, for example, as soon as the driver is in the mere proximity of the motor vehicle. In fact, even though a mobile device is restricted, by setting thresholds based on signal strength and/or position indication, access to features on a passenger's mobile device may not be restricted. As a non-limiting example, embodiments may utilize position indication data, such as GPS data associated with the driver's seat, to determine that a mobile device is more proximate to a passenger seat than to the driver's seat, subsequently refraining from restriction of functionality. As another non-limiting example, embodiments configured to evaluate the relative strength of signal transmissions may be operable to determine that a mobile device is within a maximum distance from a transmitter or receiver located in the front left area of a motor vehicle, subsequently restricting access to functionality based on the presumption that a user of the device may be in position to drive the vehicle.

Further, it is contemplated that some embodiments may utilize combinations of position indication technology, wireless radio frequency standards and other status indicators to generate application logic. As a non-limiting example, an embodiment of an automated presence detector for motor vehicles may not deactivate a driver's mobile device unless the Bluetooth signal transmitted by the mobile device is determined to be of a minimum strength, the GPS coordinate data of the mobile device and the motor vehicle overlap, and the motor vehicle is moving at a speed in excess of twenty miles per hour. As another non-limiting example of application logic, or methodology as the case may be, that may be comprised within some embodiments, full access to the functions, features and applications of a mobile device may be activated when the positioning coordinates of the motor vehicle correlate with a space other than a roadway and/or the ignition in the vehicle is in the “off” position. In yet another non-limiting example, the limited access status of the mobile device can be confirmed as correct, and not overridden, by comparing the position indication data of the motor vehicle with the position indication data of the mobile device. Again, position indication may be determined by GPS, for example, or even in a relative manner using signal strength of the system's radio frequency.

Upon entering a motor vehicle with integrated Bluetooth technology, or similar equipment, a person carrying a Bluetooth enabled mobile device may be recognized by the motor vehicle as “present” and, presumably, in position to drive. The presence of the driver is detected and confirmed by the motor vehicle as the Bluetooth device carried by the driver automatically “pairs” itself with the receiver residing within the motor vehicle. Once the mobile device and motor vehicle have successfully paired, access to functions or features of the mobile device can be limited so as to prevent the driver from being distracted. For example, the “ringtone” of the mobile device could be automatically set to “silent,” the web browser function could be deactivated, the dialing capabilities could be locked out, or the device could be altogether turned off.

The “pairing” methodology, generally, is the means by which Bluetooth enabled devices recognize and communicate with one another and is well known in the art of radio frequency communication. Further, the term “pair,” or any conjugate thereof, is used herein generally to describe the step in which a component of an automated presence detector for motor vehicles may recognize and/or verify the presence of another component within the system. For this reason, even though some embodiments of an automated presence detector for motor vehicles may establish a paired connection as is known in the specific art of Bluetooth technology, the interpretation of the present disclosure will not be limited to Bluetooth specific pairing, even when the word “pair,” or its conjugates, is used in conjunction with the word “Bluetooth” in an exemplary description.

Even further, though the present disclosure commonly refers to the Bluetooth technology, it is contemplated that other radio frequency standards, IR wavelength signals, WiFi technologies, position indication methodologies or any suitable communication/protocol technology or methodology may be comprised within various embodiments of an automated presence detector for motor vehicles and the employment of any given communication standard or protocol, or lack thereof, will not limit the scope of that which is disclosed. Accordingly, reference to the Bluetooth radio frequency is offered for illustrative purposes only and should not be read such that embodiments of an automated presence detector for motor vehicles are limited to comprising only Bluetooth technology or ranges. The use of Bluetooth in this disclosure, therefore, can be substituted by any number of wireless communication technologies including, but not limited to, WiFi standards, 802.1x standards, or any communication protocol useful for transmitting data over a wireless connection. Moreover, though the Bluetooth technology is generally limited to a transmission range under 100 meters (commonly under 10 m), such a typical transmission range is a function of system power and frequency and will not be read to imply a limit on the effective range of an automated presence detector for motor vehicles.

Some embodiments of an automated presence detector for motor vehicles may be operable to not only recognize that a mobile device is proximate to a motor vehicle or a restricted zone, but may also restrict or allow access to mobile device functionality based on the identification of the driver associated with a particular mobile device. Stated another way, embodiments may be able to query a mobile device identifier to determine the user/driver associated with that mobile device and, based on that identification, transmit (or refrain from transmitting) actuation signals to cause the mobile device to limit access to functionality. For instance, should a teenage driver enter a motor vehicle, the automated presence detector for motor vehicles may operate to completely deactivate the driver's cellular telephone whereas should the teenage driver's father get behind the wheel of the motor vehicle, the system may refrain from limiting access to his Blackberry.

As an alternative to the embodiment just described, embodiments of an automated presence detector for motor vehicles that comprise an application running on the mobile device that does not require actuation signals from an application integrated into the motor vehicle, may include features that enable access to be determined based on settings within the mobile device application. Moreover, applications residing on a mobile device may also be operable to receive indications of multiple users such that access is limited to a level associated with the instant user of the mobile device. Even further, it is contemplated that embodiments of an automated presence detector for motor vehicles may feature “override” capabilities such that the application itself may be deactivated.

It is contemplated that the mobile device associated with a driver may typically be a cellular based mobile device, an application running on a mobile device or some other device that is uniquely associated with a specific user. Even so, a Bluetooth capable device that is not a telephone, PDA, pager or the like could also be substituted. Additionally, a device specifically designed to pair with a motor vehicle's specific receiver/system could also be used.

With regards to exemplary components that may be integrated into motor vehicles in embodiments of an automated presence detector for motor vehicles, a Bluetooth receiver, or another receiver configured to receive data via a wireless and automatic radio frequency standard, can be integrated into the motor vehicle controls or can operate as an “aftermarket” adjunct to a motor vehicle. As is known in the art, the receiver in the motor vehicle will poll to determine the presence of previously identified Bluetooth devices. If any such device is present, then the application within the motor vehicle will transmit actuation signals to the mobile device instructing the device to limit functionality according to a certain level. Alternatively, a receiver in the mobile device may poll to determine the presence of a motor vehicle and, based on that presence or the identification of the vehicle, subsequently restrict access to its functionality. It is contemplated that embodiments of the system will require a simple set up process in order to register each potential user/driver such that a specific Bluetooth device can be associated with a driver.

### BRIEF DESCRIPTION OF THE SEVERAL VIEWS OF THE DRAWING

FIG. 1 illustrates an exemplary environment in which embodiments of an automated presence detector for motor vehicles may be employed.

FIG. 2 depicts an exemplary methodology used by some embodiments of an automated presence detector for motor vehicles, wherein a component associated with a motor vehicle dictates mobile device access levels.

FIG. 3 depicts an exemplary methodology used by some embodiments of an automated presence detector for motor vehicles, wherein the mobile device component dictates mobile device access levels.

FIG. 4 depicts an exemplary methodology used by some embodiments of an automated presence detector for motor vehicles, wherein mobile device access restrictions are triggered by position indication coordinates.

FIG. 5 depicts an exemplary methodology used by some embodiments of an automated presence detector for motor vehicles, wherein position indication coordinates are used to verify application status.

FIG. 6 depicts an exemplary methodology used by some embodiments of an automated presence detector for motor vehicles, wherein mobile device access restrictions are triggered by signal strength of radio frequency.

FIG. 7 depicts an exemplary methodology used by some embodiments of an automated presence detector for motor vehicles, wherein mobile device access restrictions are triggered by identification of motor vehicle.

FIG. 8 is a functional block diagram of components comprised within an exemplary embodiment of an automated presence detection system.

### DETAILED DESCRIPTION

The presently disclosed embodiments, as well as features and aspects thereof, are directed towards providing a system that can recognize the physical proximity of a mobile device to a motor vehicle or a restricted zone, subsequently limiting, enabling or restricting access to mobile device functionality. A restricted zone, while in some embodiments is defined to comprise a motor vehicle, in other embodiments may be in a location such as, but not limited to, a school, church or movie theatre. Further, some embodiments may employ wireless and automatic radio frequency standards such as, for example, Bluetooth. Still other embodiments may compare more precise position indication data, such as GPS coordinates, of a motor vehicle with that of a mobile device before restricting access. Even further, some embodiments may combine position indication technologies, as well as other go/no go status indications, to provide redundancy or define suitable scenarios for limiting mobile device access.

Generally, embodiments are operable to recognize or detect the mutual proximity of components. Once mutual proximity of components is detected and the identification of the components verified, functionality associated with at least one of the components is limited, activated, deactivated or otherwise restricted.

It is contemplated that some embodiments may simultaneously limit, activate, deactivate or otherwise restrict user access to functionality associated with multiple components. Further, some embodiments may recognize or detect the mutual proximity of more than two components and subsequently modify user access to functionality for each, some, or one of the components. Still other embodiments may limit, activate, deactivate or otherwise restrict user access to functionality associated with various components at varying levels. Also, some embodiments may vary user access levels to functionality of a component based on the identification of other components with which it shares mutual proximity. Additionally, some embodiments may limit user access to functionality of any component which is mutually proximate to a particular component.

Turning now to the figures, where like labels represent like elements throughout the drawings, various aspects, features and embodiments of an automated presence detector are presented in more detail. The examples as set forth in the drawings and detailed description are provided by way of explanation and are not meant as limitations on the scope of an automated presence detector for motor vehicles. An automated presence detector for motor vehicles thus includes any modifications and variations of the following examples as come within the scope of the appended claims and their equivalents.

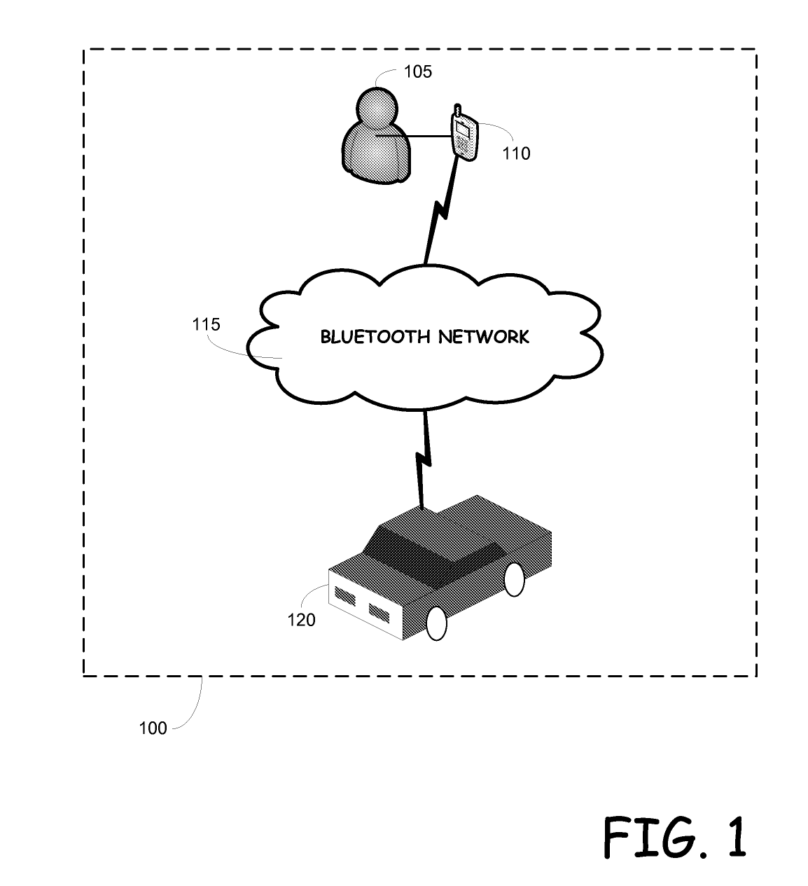

FIG. 1 illustrates an exemplary environment in which embodiments of an automated presence detector for motor vehicles may be employed. The motor vehicle 120 may comprise a transmitter, receiver and controls package that are configured to pair and communicate with mobile devices 110 having complimentary functionality. More specifically, a user/driver 105 of a motor vehicle 120 may configure a Bluetooth enabled personal mobile device 110 such as, for example, a cellular telephone to pair with a Bluetooth enabled motor vehicle 120. Once paired, it is known in the art that functionality associated with the personal mobile device 110 may be integrated into the controls system of the motor vehicle 120. For example, an incoming audio communication directed to the mobile device 110 may be transferred through the integrated sound system of the motor vehicle 120.

What is not known in the art, however, is a means by which access to the functionality of a mobile device 110 may be restricted, or altogether disabled, when the device 110 is paired with the system of the motor vehicle 120 or simply detected as being present. An automated presence detector for motor vehicles provides, among other aspects, just such a means. A zone 100 defined by the effective transmission range of the mobile device 110 and/or the Bluetooth transmitter of the motor vehicle 120 contains a wireless network 115 suitable for the communication previously described. Recognition of mutual proximity between the controls package of a motor vehicle 120 and that of a mobile device 110, i.e. a shared zone 100, may be used as a trigger to limit access to mobile device 110 functions.

An application running on the mobile device 110 may be invoked by the mobile device upon recognition that the device 110 is proximate to the motor vehicle 120. The invoked application may be configured to limit access to functions or other applications embodied within the mobile device 110 so long as the device 110 remains within the zone 100 defined by the radio frequency network 115. Advantageously, by limiting access to mobile device functionality based on proximity to a motor vehicle 120, an automated presence detector for motor vehicles may prevent a user/driver 105 associated with a mobile device 110 from being distracted, or otherwise engage in unsafe behavior, while operating the motor vehicle 120.

It is contemplated that a motor vehicle may be any motorized mode of transportation such as, but not limited to, automobiles, trucks, motorcycles, scooters, airplanes, boats, helicopters, etc. Further, although the present disclosure illustrates the applications and merits of various embodiments of an automated presence detector for motor vehicles in conjunction with a motor vehicle environment, it is contemplated that other embodiments may be employed in a non-motor vehicle based environment such as, but not limited to, an industrial plant control room, an air traffic control station, a church, a school classroom, an auditorium, gas pumps during a refueling session, machinery operation, a movie theatre, or any environment wherein it is an advantage that distractions or signals emanating from mobile devices be minimized. Further, such embodiments geared toward fixed locations, as opposed to those embodiments tailored to a zone comprising a given motor vehicle, may be configured to define a “quiet zone” wherein mobile device applications or various functionalities such as, but not limited to, ringers or alerts may be automatically disabled. Moreover, in lieu of a “quiet zone,” certain embodiments targeted toward fixed locations, such as edifices, public areas, venues or the like may conceivably be configured to actually lift restrictions, i.e. enable applications or functionalities as the time and location dictates. It will be understood, however, that embodiments of an automated presence detector for motor vehicles will anticipate that which is an obvious extension of the detail disclosed herein including, but not limited to, embodiments with varying natures of a defined zone, different levels of enabling or disabling of mobile device applications and/or functionalities, or different purposes of use. Also, while a mobile device is generally described herein as a cell phone or PDA, it is anticipated that a mobile device may be any “mobile device” such as, but not limited to, cameras, video recorders, pagers, memory devices, computers, scanners, infrared cameras, video game devices, etc.

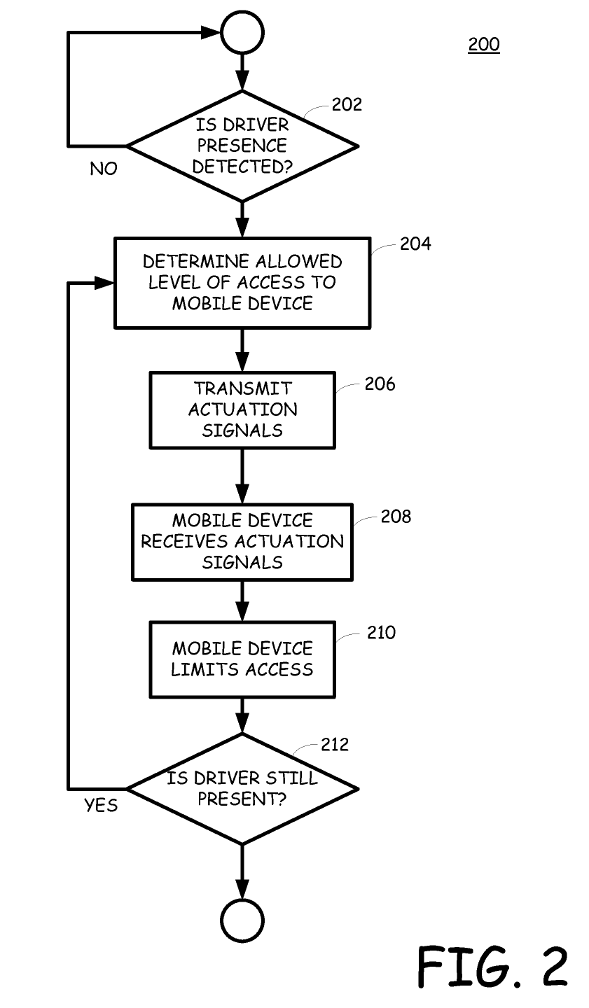

FIG. 2 depicts an exemplary methodology 200 used by some embodiments of an automated presence detector for motor vehicles, wherein a component associated with a motor vehicle dictates mobile device access levels. As has been described, an advantageous aspect of many embodiments of an automated presence detector for motor vehicles is automatic restriction of access to the functionality of a mobile device. An application component running on a hardware component of the system may be triggered to execute by the pairing of a mobile device with the controls package of a motor vehicle. The application component, in some embodiments of an automated presence detector for motor vehicles, may reside and run on the controls package component of the motor vehicle.

In such an embodiment, the Bluetooth enabled controls package of a motor vehicle will poll 202 the effective transmission zone 100 to identify the presence of a user/driver's 105 associated mobile device 110. Again, by detection or pairing with a user's 105 mobile device 110, the system presumes the physical presence of the associated user 105. If polling 202 identifies the presence of a user, the application component running on the controls package of the motor vehicle 120 determines 204 the level of access to mobile device functionality that is allowed so long as the mobile device 110 remains in the zone 100.

It is contemplated that the determination 204 of access level may be queried from a database of predetermined access levels wherein the database resides within the controls package of the motor vehicle. Alternatively, the database could also reside at a central location, such as a remote service provider, and be accessible for query via wireless communications technologies and/or methods known in the art. Moreover, the access level could be transmitted to the motor vehicle's controls package from the mobile device itself. Regardless of the methodologies used by various embodiments to store or query mobile device access levels, methodologies which may be novel in and of themselves, a combination of such data management methodologies with an embodiment of an automated presence detector for motor vehicles is considered herein to be obvious and, as such, the inclusion or exclusion of any data management methodology with a given embodiment will not serve to limit the scope of an automated presence detector for motor vehicles.

Upon determination 204 of the appropriate access level, the application may cause the controls package to transmit 206 actuation signals to the mobile device that instruct the mobile device to limit 210 user access to certain functionality. More specifically, upon receipt 208 of the actuation signals, a complimentary application running on the mobile device may automatically limit access 210 to one or more functions. The controls package of the motor vehicle will continue to poll 212 the effective zone 100 to verify the continued presence of the mobile device 110, ergo the continued presence of the user 105. So long as the mobile device 110 remains within the effective zone 100, the controls package will verify the access level of the mobile device 110 and cause the device to maintain 210 such limited access. It is contemplated that a complimentary application running on the mobile device may seek to restore default access settings, subject to override by receipt 208 of actuation signals, such that the default settings may be restored when the mobile device is removed from the effective zone 100.

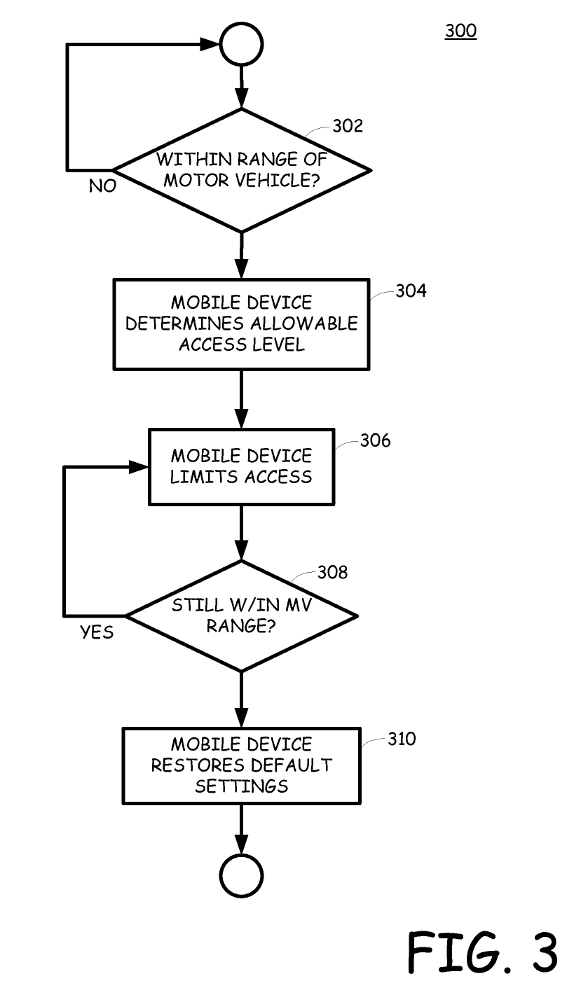

FIG. 3 depicts an exemplary methodology used by some embodiments of an automated presence detector for motor vehicles, wherein the mobile device component dictates mobile device access levels. Again, an advantageous aspect of many embodiments of an automated presence detector for motor vehicles is automatic restriction of access to the functionality of a mobile device. An application component running on a hardware component of the system, such as the mobile device itself, may be triggered to execute by the pairing of a mobile device with the controls package of a motor vehicle or simply a Bluetooth or similar transmitter being detected or paired with the mobile device. The application component, in some embodiments of an automated presence detector for motor vehicles, may reside and run on the mobile device.

In such an embodiment, the Bluetooth enabled mobile device will poll 302 the effective transmission zone 100 to identify its proximity to a motor vehicle 120. If polling 302 identifies proximity to a motor vehicle, the application component running on the mobile device determines 304 the level of access to mobile device functionality that is allowed so long as the mobile device 110 remain in the zone 100.

As has been described, it is contemplated that the determination 304 of access level may be queried in any number of ways. An embodiment of an automated presence detector for motor vehicles wherein an application residing on the mobile device determines the appropriate access level to device functionality may not necessarily query a database to determine the access level. Rather, because the application may be uniquely associated with the particular mobile device, it is contemplated that the access level for the particular device may be preset within the mobile device, thus obviating the need for the application to query a database potentially containing multiple mobile device access levels. For instance, an administrator of a mobile device may have programming access to define the restrictions and conditions on the mobile device. Again, regardless of the methodologies used, or not used, by various embodiments to store or query mobile device access levels, a combination of such data management methodologies with an embodiment of an automated presence detector for motor vehicles is anticipated and, as such, the inclusion or exclusion of any data management methodology with a given embodiment will not serve to limit the scope of an automated presence detector for motor vehicles.

Upon determination 304 of the appropriate access level, the application may cause the mobile device to limit 306 access to functionality. Advantageously, the limiting 306 of access to mobile device functionality may be maintained so long as the mobile device is paired 308 with a Bluetooth enabled motor vehicle 120, thus limiting possible distractions while a user 105 who is associated with the mobile device 110 is driving the motor vehicle 120. It is contemplated that the application running on the mobile device may be operable to simply restore 310 default access settings upon exit from the effective zone 100, i.e. by recognizing the absence of disabling signals.

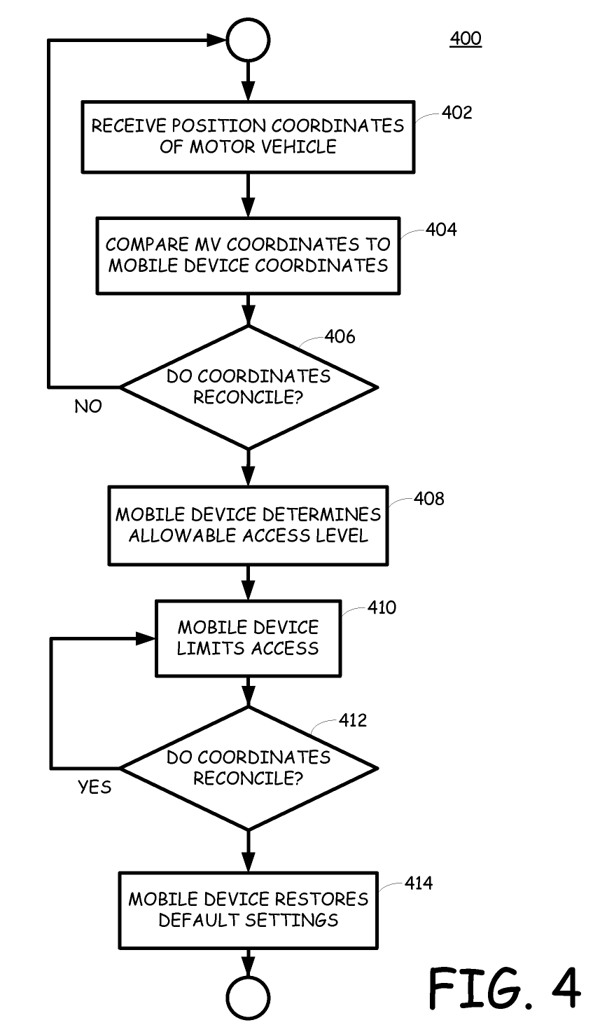

FIG. 4 depicts an exemplary methodology 400 used by some embodiments of an automated presence detector for motor vehicles, wherein mobile device access restrictions are triggered by position indication coordinates. The methodologies described above relative to FIGS. 2 and 3 are exemplary in nature in that each anticipates an embodiment of an automated presence detector for motor vehicles that makes use of a wireless radio frequency standard, such as Bluetooth. The exemplary methodology of FIG. 4, on the contrary, illustrates an alternative method for determining that a mobile device 110, therefore the user 105 associated with a mobile device, is in proximity to a motor vehicle 120.

Generally, position indication coordinates associated with a motor vehicle may be compared to coordinates associated with a mobile device such that if the coordinates represent closely positioned locations, an application running on a component of an automated presence detector for motor vehicles may be triggered. As has been described, an application for determining proximity and dictating access levels may reside on any number of components comprised within an embodiment of an automated presence detector for motor vehicles. The illustrative methodology 400 of FIG. 4 assumes such application residing on a mobile device, but such is exemplary in nature and will not be interpreted to limit the scope of an automated presence detector for motor vehicles which uses position coordinate data.

The mobile device may receive 402 position coordinate data representative of the physical location of a motor vehicle. Subsequently, position coordinate data representative of the mobile device location may be compared 404 with the received 402 motor vehicle data. If the coordinates reconcile 406, i.e. the coordinates of the mobile device and motor vehicle are determined to be close in proximity, the application running on the mobile device may be triggered to determine 408 the allowable level of access to mobile device functionality and, subsequently, restrict 410 access accordingly. Importantly, it is contemplated that the acceptable range of proximity may be predetermined and “programmed” into the mobile device application.

Once mobile device access to functionality has been limited 410 based on the proximity of position coordinates between the motor vehicle and mobile device, the system may continue 412 to query the position coordinates in an effort to determine that proximity is maintained. So long as proximity is maintained, access to mobile device functionality will continue to be limited 410. Should it be determined that the position coordinates of the motor vehicle and mobile device are outside a predetermined range of proximity, the mobile device may be operable to restore 414 default access settings.

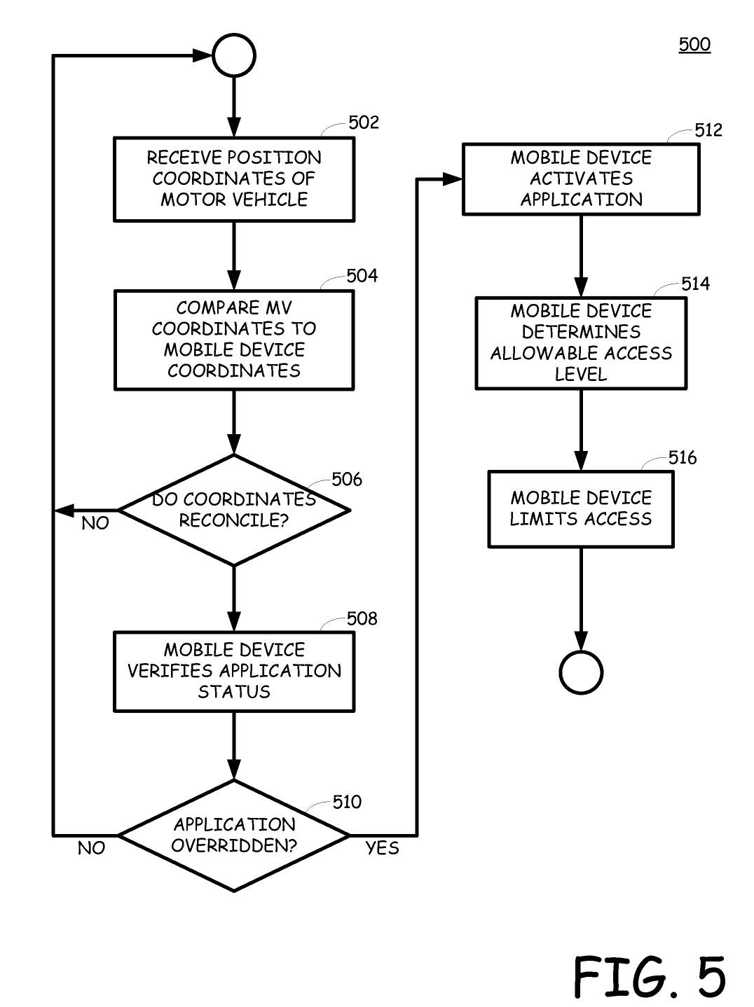

FIG. 5 depicts an exemplary methodology 500 used by some embodiments of an automated presence detector for motor vehicles, wherein position indication coordinates are used to verify application status. Advantageously, embodiments that comprise methodologies such as the exemplary methodology 500 illustrated in FIG. 5 may combine relatively precise position indication technologies, such as GPS, with other proximity indication means, such as radio frequency. As it is contemplated that embodiments of an automated presence detector for motor vehicles may provide a means for overriding the application component such that automatic limitation or restriction of mobile device functionality is deactivated, some embodiments may comprise methodologies that incorporate redundancy measures for the purpose of preventing unauthorized overriding of the application.

For example, an embodiment that incorporates the methodology 500 may initially trigger execution of an application by means of a wireless radio standard, by way of such exemplary methodologies as those described relative to FIGS. 2 and 3. To subsequently verify that access limitations have not been overridden, the embodiment may receive 502 position indication coordinates, such as those from a GPS, of the motor vehicle and compare 504 those coordinates to position indication coordinates of the mobile device. If the coordinates reconcile 506 such that the motor vehicle and mobile device are considered to be in close proximity, an application running on the mobile device, or some other component within the system of the embodiment, may verify 508 that the access limitations are active. If it is determined 510 that the access limits have been overridden, or the application deactivated, the mobile device may restart or activate 512 the access limiting application, at which point the device will determine 514 the appropriate access level and subsequently limit 516 access to device functionality per the process(es) previously described.

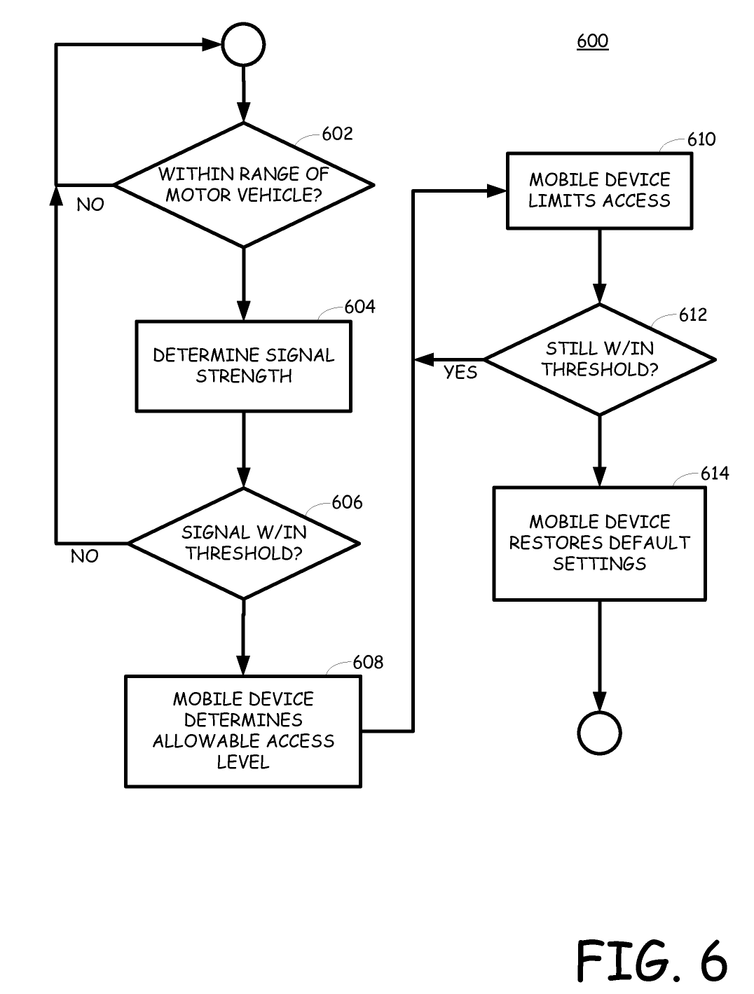

FIG. 6 depicts an exemplary methodology used by some embodiments of an automated presence detector for motor vehicles, wherein mobile device access restrictions are triggered by signal strength of radio frequency. An embodiment of an automated presence detector for motor vehicles that comprises exemplary methodology 600 operates similarly to that which has been described relative to FIGS. 2 and 3.

More specifically, an embodiment that comprises methodology 600 may employ an automatic wireless radio frequency standard such as Bluetooth. An application running on a mobile device component, for example, may poll 602 to determine if the mobile device is proximate to a motor vehicle transmitter. Unlike the exemplary methodologies described relative to FIGS. 2 and 3, however, an embodiment using a methodology such as that illustrated in FIG. 6 will not trigger limitations on mobile device access levels unless the detected signal strength of the radio frequency is determined 604 to be of a certain level. In this way, it is an advantage that such an embodiment may resist limiting access to mobile device functionality unless it is at least probable that the user associated with the device is actually in the motor vehicle, i.e. the signal strength is strong due to user proximity to a transmitter integrated with the motor vehicle controls package.

If the signal strength is determined 604 to be of a certain minimum strength 606, the application will proceed to determine 608 the allowable access level and subsequently limit 610 access accordingly. As long as the signal remains 612 within the predetermined strength threshold, the mobile device will continue to limit 610 access to functionality. Alternatively, if the signal strength weakens such that threshold is no longer met, the system may presume that the user is not driving the motor vehicle and, subsequently, restore 614 default access levels.

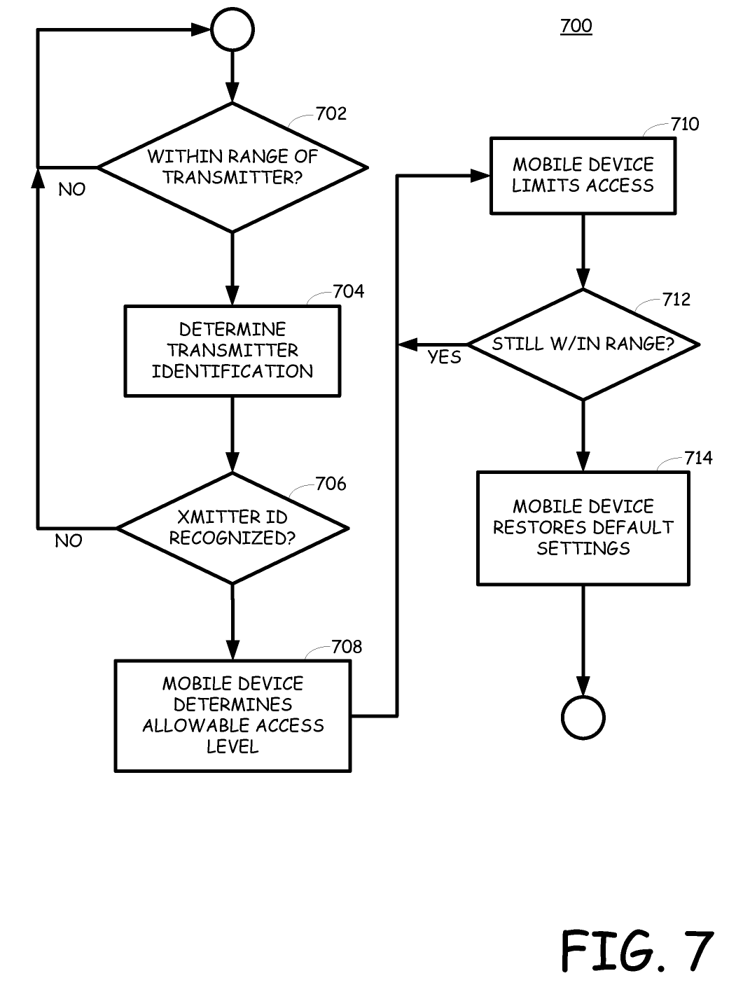

FIG. 7 depicts an exemplary methodology used by some embodiments of an automated presence detector for motor vehicles, wherein mobile device access restrictions are triggered by identification of a motor vehicle. It is contemplated that embodiments of an automated presence detector for motor vehicles will seek to limit access to mobile device functionality only if the mobile device is sufficiently proximate to a specific motor vehicle (or vehicles). An embodiment comprising exemplary methodology 700, or similar methodologies, will comprise such an advantageous feature.

For example, similar to methodologies previously disclosed, an embodiment utilizing methodology 700 will initially recognize 702 that a mobile device is within a zone 100 defined by the transmission strength of a transmitter within a motor vehicle. Upon making such determination, an identity associated with the specific transmitter may be determined 704 such that if the transmitter is recognized 706 by the mobile device application then the mobile device will proceed to determine 708 the appropriate level of access to functionality. At such point, similar to previously described methodologies, the mobile device may limit 710 access accordingly so long as the mobile device remains 712 within range of the identified transmitter. Upon determination 712 that the mobile device is no longer proximate to the identified transmitter, the mobile device may restore 714 default access settings.

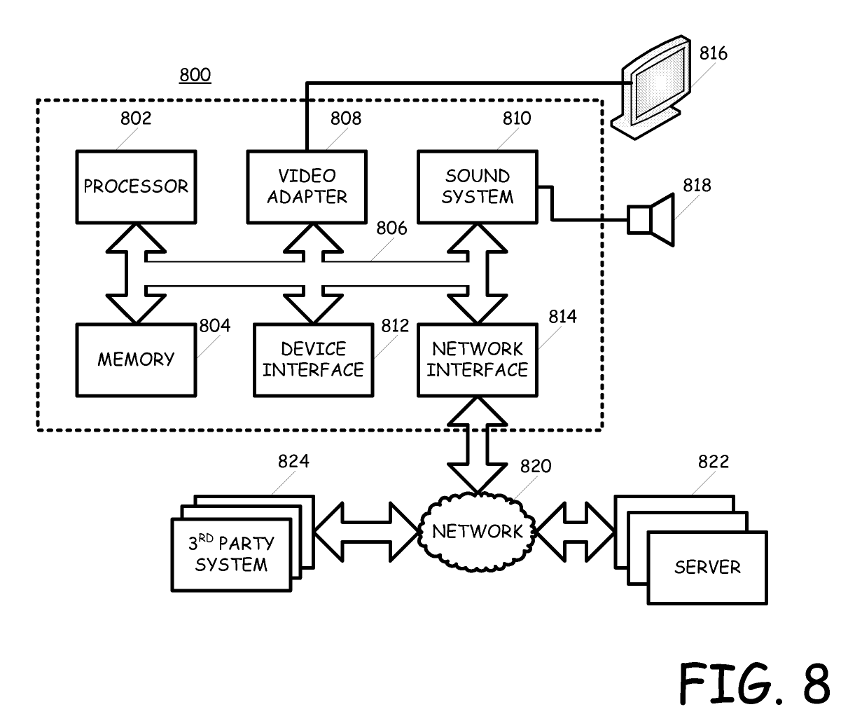

FIG. 8 is a functional block diagram of the components of an exemplary embodiment of an automated presence detector for motor vehicles. It will be appreciated that not all of the components illustrated in FIG. 8 are required in all embodiments of the automated presence detector for motor vehicles system but, each of the components are presented and described in conjunction with FIG. 8 to provide a complete and overall understanding of the components.

The exemplary automated presence detector for motor vehicles system 800 can include a general computing platform illustrated as including a processor/memory device 802, 804 that may be integrated with each other or, communicatively connected over a bus or similar interface 806. The processor 802 can be a variety of processor types including microprocessors, micro-controllers, programmable arrays, custom IC's etc. and may also include single or multiple processors with or without accelerators or the like. The memory element of 804 may include a variety of structures, including but not limited to RAM, ROM, magnetic media, optical media, bubble memory, FLASH memory, EPROM, EEPROM, etc.

The processor 802, or other components, may also provide functions such as a real-time clock, analog to digital converters, digital to analog converters, etc. The processor 802 may also interface to a variety of elements including, but not limited to, a device interface 812, a display adapter 808, audio adapter 810, and network/device interface 814. The device interface 812 provides an interface to external controls, such as sensors, actuators or the like.

The display adapter 808 can be used to drive a variety of content display elements 816, such as display devices including an LED display, LCD display, one or more LEDs or other display devices. The audio adapter 810 interfaces to and drives another content display element 818, such as a speaker or speaker system, buzzer, bell, etc. The network/device interface 814 may interface to a variety of devices (not shown) such as a keyboard, a mouse, a pin pad, and audio activate device, a PS3 or other game controller, as well as a variety of the many other available input and output devices or, another computer or processing device 822, 824.

Further, the network/device interface 814 can also be used to interface the computing platform to other devices, such as a receiving entity or content provider, through a network 820. The network may be a local network, a wide area network, wireless network, a global network such as the Internet, or any of a variety of other configurations including hybrids, etc. The network/device interface 814 may be a wired interface or a wireless interface. The computing platform is shown as interfacing to a server 822 and a third party system 824 through the network 820.

It will be appreciated that other functions may be performed by various embodiments of a presence detector. For instance, devices such as automobiles, heavy machinery, gas pumps, etc. may include functionality to detect the presence of a mobile device and either sound a warning that continued use is prohibited, prevent the commencement of use or even disable the equipment in some circumstances.

An automated presence detector for motor vehicles has been described using detailed descriptions of embodiments thereof that are provided by way of example and are not intended to limit the scope of the system. The described embodiments comprise different features, not all of which are required in all embodiments of an automated presence detector for motor vehicles. Some embodiments of an automated presence detector for motor vehicles utilize only some of the features, or possible combinations of the features, described relative to the exemplary embodiments. Variations of embodiments of an automated presence detector for motor vehicles that are described and embodiments of an automated presence detector for motor vehicles comprising different combinations of features noted in the described embodiments will occur to persons of the art.

It will be appreciated by persons skilled in the art that an automated presence detector for motor vehicles is not limited by what has been particularly shown and described herein above. Rather, the scope of an automated presence detection system is defined by the claims that follow.

What is claimed is:

1. A system for recognizing the mutual proximity of two components, the system comprising:
a first component comprising a wireless radio frequency receiver;
a second component comprising a wireless radio frequency transmitter, wherein the effective range of the transmitter defines maximum boundaries of a particular zone; and
a processor, wherein when said first component is physically present in said particular zone, the processor being configured to restrict user access to functionality of at least one of said first and second components.

2. The system of claim 1, wherein:
the first component is a mobile device;
the second component is a controls package of a motor vehicle; and
the processor is integrated within said mobile device, wherein, when the mobile device is physically present within said particular zone and the receiver of the mobile device recognizes signal frequencies transmitted from said motor vehicle controls package, the processor is configured to:
determine an authorized level of user access to the functionality of the mobile device;
limit user access to mobile device functionality according to the authorized level;
monitor the continued receipt of signal frequencies transmitted from the motor vehicle controls package;
maintain limited level of user access to functionality; and
wherein monitored signal frequencies are no longer received, restore default user access settings.

3. The system of claim 2, wherein the mobile device is selected from a group consisting of a cellular telephone, a personal digital assistant (PDA), and a personal computer.

4. The system of claim 1, wherein the wireless radio frequency meets the Bluetooth standard.

5. The system of claim 1, wherein the processor is further configured to:
determine the relative proximity of the first and second components within the particular zone; and
wherein the relative proximity is within a predetermined threshold:
determine an authorized level of user access to the functionality of at least one of said first and second components;
limit user access to the component functionality according to the authorized level;
monitor the continued relative proximity of the first and second components within the particular zone;
maintain limited level of user access to functionality; and
wherein the relative proximity of the first and second components exceeds the predetermined threshold, restore default user access settings.

6. The system of claim 5, wherein the relative proximity of the first and second components within the particular zone is calculated based on the measured strength of radio frequency signals.

7. The system of claim 1, further comprising a second processor, wherein:
the first component further comprises a radio frequency transmitter;
the second component further comprises a radio frequency receiver;
the first processor is integrated with the first component, wherein, when the first component is physically present in said particular zone, the first processor is configured to:
determine an authorized level of user access to the functionality of the second component; and
cause transmission of actuation signals representative of the determined authorized level to the second component;
the second processor is integrated with the second component, the second processor being configured to:
recognize actuation signals received from the first component;
based on the recognized actuation signals, limit user access to functionality of the second component according to an authorized level;
monitor the continued presence of the second component in the particular zone;
maintain limited level of user access to functionality; and
wherein the second component is no longer present in the particular zone, restore default user access settings.

8. The system of claim 7, wherein:
the first processor is configured to:
determine the relative proximity within the particular zone of the first component to the second component; and
wherein the relative proximity is within a predetermined threshold:
determine an authorized level of user access to the functionality of the second component; and
cause transmission of actuation signals representative of the determined authorized level to the second component; and
the second processor is configured to:
recognize actuation signals received from the first component;
based on the recognized actuation signals, limit user access to functionality of the second component according to an authorized level;
monitor the continued relative proximity of the first and second components within the particular zone;
maintain limited level of user access to functionality; and
wherein the relative proximity of the first and second components exceeds the predetermined threshold, restore default user access settings.

9. The system of claim 8, wherein the relative proximity of the first and second components within the particular zone is calculated based on the measured strength of radio frequency signals.

10. A system for recognizing the mutual proximity of two components, the system comprising:
a first component comprising a receiver operable to receive data representative of position coordinates;
a second component comprising a transmitter operable to transmit data representative of position coordinates associated with the second component; and
a processor, wherein when the physical positions of the first and second components are in close proximity, the processor being configured to restrict user access to functionality of at least one of said first and second components.

11. The system of claim 10, wherein:
the first component is a mobile device;
the second component is a controls package of a motor vehicle; and
the processor is integrated with said mobile device, wherein, when the mobile device is closely proximate to the motor vehicle controls package, the processor is configured to:
compare the position coordinate data of the mobile device and motor vehicle controls package; and
wherein the positions of the mobile device and motor vehicle controls package are determined to be in close proximity:
determine an authorized level of user access to the functionality of the mobile device;
limit user access to functionality of the mobile device according to the authorized level;
monitor the proximity of the mobile device to the motor vehicle controls package;
maintain limited level of user access to functionality; and
wherein the monitored positions of the mobile device and motor vehicle controls package are no longer in close proximity, restore default user access settings of the first component.

12. The system of claim 11, wherein the mobile device is selected from a group consisting of a cellular telephone, a personal digital assistant (PDA), and a personal computer.

13. The system of claim 10, wherein the position coordinates data is associated with the Global Positioning System (GPS).

14. The system of claim 10, further comprising a second processor, wherein:
the first component further comprises a position coordinate data transmitter;
the second component further comprises a position coordinate data receiver;
the first processor is integrated with the first component, wherein, when the first component is closely proximate to the second component, the first processor is configured to:
determine an authorized level of user access to the functionality of the second component; and
cause transmission of actuation signals representative of the determined authorized level to the second component;
the second processor is integrated with the second component, the second processor being configured to:
recognize actuation signals received from the first component;
based on the recognized actuation signals, limit user access to functionality of the second component according to an authorized level;
monitor the continued proximity of the first and second components;
maintain limited level of user access to functionality of the second component; and
wherein the first and second components are no longer closely proximate, restore default user access settings to the second component.

15. A method for recognizing the physical proximity of a first component to a second component, wherein, based on such recognition, user access to functionality of the first component may be restricted, the method comprising the steps of:
determining that the physical proximity of a first component to a second component is within a predetermined range;
determining an authorized level of user access to the functionality of the first component;
limiting user access to the functionality of the first component according to the authorized level;
monitoring the continued proximity of the components;
maintaining limited level of user access to the functionality of the first component; and
wherein monitored proximity is no longer within the predetermined range, restoring default user access settings to the first component.

16. The method of claim 15, wherein:
the step of determining that the physical proximity of a first component to a second component is within a predetermined range further comprises:
defining the maximum boundaries of the predetermined range to be equal to the effective range of a radio frequency transmitter comprised within the second component; and
determining, via receipt of wireless radio frequency signals, that the first component is physically present within said range.

17. The method of claim 16, wherein prior to the step of determining an authorized level of user access, verifying that the transmitter is associated with a specific second component.

18. The method of claim 16, wherein prior to the step of determining an authorized level of user access, determining that the strength of the received signal frequencies meets a predetermined threshold.

19. The method of claim 15, wherein:
the step of determining that the physical proximity of a first component to a second component is within a predetermined range further comprises:
defining the maximum boundaries of a particular range to be equal to a maximum variation between position coordinate data of the first and second components; and
determining, via comparison of the position coordinate data of the first and second components, that the first component is physically present within said range.

20. The method of claim 19, wherein the position coordinates data is associated with the Global Positioning System (GPS).
